(19) United States
(12) Patent Application Publication
(10) Pub. No.: US 2026/0094847 A1
(43) Pub. Date: Apr. 2, 2026

(54) PHOSPHATE-RESISTANT CATALYST MATERIAL HAVING OPTIMUM SURFACE MODIFICATION AND METHOD OF MITIGATING PHOSPHATE POISONING IN A FUEL CELL

(71) Applicant: Toyota Motor Engineering & Manufacturing North America, Inc., Plano, TX (US)

(72) Inventors: Honghong Lin, Ann Arbor, MI (US); Siwen Wang, Livonia, MI (US); Chen Ling, Troy, MI (US); Liang Wang, Saline, MI (US); Gaohua Zhu, Ann Arbor, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/899,681

(22) Filed: Sep. 27, 2024

(51) Int. Cl. H01M 4/86; H01M 4/92; H01M 8/10

(52) U.S. Cl. CPC H01M 4/8663; H01M 4/8657; H01M 4/926; H01M 2008/1095

(57) ABSTRACT

Disclosed is a surface-modified catalyst material comprising platinum-containing nanoparticles on a carbon support; and a phosphate-resistant surface-modifying additive comprising poly (melamine-co-formaldehyde) (PMF); formed on a surface of the platinum-containing nanoparticles to form surface-modified catalyst nanoparticles. The surface-modifying additive covers between 10 and 40% of the surface of the surface-modified catalyst nanoparticles. Proton exchange membrane fuel cells and methods of mitigating phosphate poisoning are also disclosed.

### TECHNICAL FIELD

The present disclosure generally relates to a phosphate-resistant catalyst material having an optimum range of a poly (melamine-co-formaldehyde) (PMF) surface modifying additive on platinum-containing catalyst nanoparticles for proton exchange membrane fuel cells (PEMFC) and a method for mitigating phosphate poisoning of the catalyst in the fuel cell.

### BACKGROUND

The background description provided herein is for the purpose of generally presenting the context of the disclosure. Work of the presently named inventors, to the extent it may be described in this background section, as well as aspects of the description that may not otherwise qualify as prior art at the time of filing, are neither expressly not implicitly admitted as prior art against the present technology.

Fuel cell vehicles (FCVs) are considered to be more efficient than conventional internal combustion engine vehicles. Current commercially available fuel cell vehicles use polymer electrolyte membrane fuel cells (PEMFCs), which have attracted attention as an energy source for transportation instead of conventional internal combustion engines because they have a high-power density, operate at low temperatures, and have zero emission of harmful gases. Oxidation-reduction reactions (ORR), also known as redox reactions, are central to converting chemical energy into electrical energy. These reactions occur at two electrode layers, the anode and the cathode, separated by a proton exchange membrane. During fuel cell operation, the anode is supplied with hydrogen as a fuel and oxygen as an oxidant to the cathode. Then, fuel is oxidized to protons at the anode, and oxygen is reduced to water at the cathode to generate electricity.

Platinum catalysts are used in both the anode and cathode layers to facilitate the ORR reaction and to provide chemical stability, corrosion resistance, and durability to the fuel cell. Because the oxidation reduction reaction on the platinum containing catalysts is sluggish, a large amount of the platinum is needed to accelerate the reaction. Thus, the catalyst at the cathode is a main factor that determines the power generation characteristics of the PEMFC, and improving its ORR activity and performance is an important issue.

Several efforts have been made to use phosphoric acid as the proton conductor both in the membrane and electrode of PEMFCs. In fuel cells employing phosphoric acid as the proton conductor in the membrane electrode assembly (MEAs), a major issue is the poisoning of the oxygen reduction reaction catalyst (typically a platinum (Pt) containing catalyst). The phosphate anion from phosphoric acid adsorbs on Pt catalyst surface and reduces electrochemical surface area (ECSA) and the ability of Pt catalyst to bond with oxygen reduction reaction (ORR) intermediates for electrochemically catalyzing oxygen to form water. Some efforts to address the problem of phosphate poisoning in high-temperature proton exchange membrane fuel cells (HT-PEMFCs) have been to design phosphate-tolerant catalyst materials, phosphate-tolerant supports, and/or polymer exchange membranes that retain phosphoric acid. There is still a desire to develop strategies and materials to mitigate phosphate poisoning in HT-PEMFCs to maintain efficiency and longevity.

### SUMMARY

This section provides a general summary of the disclosure and is not a comprehensive disclosure of its full scope or all of its features.

In various aspects, the present teachings provide a surface-modified catalyst material comprising platinum-containing nanoparticles on a carbon support; and a phosphate-resistant surface-modifying additive comprising poly (melamine-co-formaldehyde) (PMF); formed on a surface of the platinum-containing nanoparticles to form surface-modified catalyst nanoparticles. The surface-modifying additive covers between 10 to 40% of the surface of the surface-modified catalyst nanoparticles. In some aspects of the present disclosure, the phosphate-resistant surface-modifying additive of the present disclosure covers between 20 to 35% of the surface of the surface-modified catalyst nanoparticles, or between 22% to about 33% of the surface of the surface-modified catalyst nanoparticles. In other aspects, the phosphate-resistant surface-modifying additive covers about 30% or less of the surface of the surface-modified catalyst nanoparticles, or about 26% or less of the surface of the surface-modified catalyst nanoparticles.

In some examples, the surface-modified catalyst material of the present disclosure comprises platinum-containing nanoparticles which comprise platinum alloyed with a second metal selected from nickel (Ni), cobalt (Co), iron (Fe), and copper (Cu). In some examples, the platinum-containing nanoparticles comprise nanoframes, nanowire, and facet-controlled shapes. The platinum-containing nanoparticles may have a core-shell structure and may further have a core-shell structure wherein the platinum-containing nanoparticles have a non-platinum core surrounded by a platinum shell. In at least one example, the platinum-containing nanoparticles are intermetallic L1₀-PtCo catalyst nanoparticles supported on carbon (L1₀-PtCo/C). The L1₀-PtCo/C catalyst nanoparticles may have a particle size in a range of about 2 to about 20 nm.

In other aspects, the present disclosure provides a proton exchange membrane fuel cell (PEMFC) comprising a surface-modified catalyst material comprising platinum-containing nanoparticles on a carbon support; and a phosphate-resistant surface-modifying additive comprising poly (melamine-co-formaldehyde) (PMF) formed on a surface of the platinum-containing nanoparticles to form surface-modified catalyst nanoparticles, wherein the phosphate-resistant surface-modifying additive covers between 10 and 40% of the surface of the surface-modified catalyst nanoparticles. The proton exchange membrane fuel cell (PEMFC) may be a high-temperature proton exchange membrane fuel cell (HT-PEMFC), wherein the phosphate-resistant surface-modifying additive covers about 22% to about 33% of the surface of the surface-modified catalyst nanoparticles.

In yet another aspect, the present disclosure provides a method for mitigating phosphoric acid poisoning in polymer electrolyte fuel cells comprising phosphoric acid or phosphonated ionomers as a proton conductor or a catalyst binder, which includes providing at least one catalyst layer which comprises a surface-modified catalyst material to an electrode in a proton exchange membrane fuel cell (PEMFC). The surface-modified catalyst material comprises platinum-containing nanoparticles on a carbon support; and a phosphate-resistant surface-modifying additive comprising poly (melamine-co-formaldehyde) (PMF) formed on a surface of the platinum-containing nanoparticles to form surface-modified catalyst nanoparticles. The phosphate-resistant surface-modifying additive covers between 10 to 40% of the surface of the surface-modified catalyst nanoparticles. In some aspects of the present disclosure, the phosphate-resistant surface-modifying additive of the present disclosure covers between 20 to 35% of the surface of the surface-modified catalyst nanoparticles, or between 22% to about 33% of the surface of the surface-modified catalyst nanoparticles. In other aspects, the phosphate-resistant surface-modifying additive covers about 30% or less of the surface of the surface-modified catalyst nanoparticles, or about 26% or less of the surface of the surface-modified catalyst nanoparticles.

In some examples, the method of method for mitigating phosphoric acid poisoning in polymer electrolyte fuel cells comprising phosphoric acid or phosphonated ionomers as a proton conductor or a catalyst binder of the present disclosure includes employing platinum-containing nanoparticles which comprise platinum alloyed with a second metal selected from nickel (Ni), cobalt (Co), iron (Fe), and copper (Cu). In some examples, the platinum-containing nanoparticles comprise nanoframes, nanowire, and facet-controlled shapes. The platinum-containing nanoparticles may have a core-shell structure and may further have a core-shell structure wherein the platinum-containing nanoparticles have a non-platinum core surrounded by a platinum shell. In at least one example, the platinum-containing nanoparticles are intermetallic L1₀-PtCo catalyst nanoparticles supported on carbon (L1₀-PtCo/C). The L1₀-PtCo/C catalyst nanoparticles may have a particle size in a range of about 2 to about 20 nm.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings wherein:

FIG. 1A is an illustration of the typical structure of a proton exchange membrane fuel cell (PEMFC) 100.

FIG. 1B is an illustration of an enlarged view of an interface section labeled 1B in 1A.

FIG. 1C is an illustration of an enlarged view of a traditional carbon support loaded with metal catalyst particles in the interface in FIG. 1B.

FIG. 2 is an illustration of a typical membrane electrode assembly (MEA) 110.

FIG. 3 is an illustration of an exemplary surface modification scheme to form a surface modified catalyst material of the present disclosure, using poly (melamine-co-formaldehyde) (PMF) as the phosphate-resistant surface-modifying additive.

FIG. 4 shows a plot of intensity versus angle for an x-ray diffraction (XRD) scan of the L1₀-PtCo/C catalyst material of the present disclosure showing an intermetallic peak (110) peak at 33.6°.

FIG. 5 is a schematic illustration of a method of surface modification with the phosphate-resistant surface modifying agent on an electrode.

FIG. 6A is a cyclic voltammogram (CV) graph of L1₀-PtCo/C before and after surface modification with poly (melamine-co-formaldehyde) (PMF) (Modified-L1₀Pt/Co/C).

FIG. 6B is a graph illustrating the comparison of linear sweep voltammetry curves (LSV) of a standard platinum on carbon catalyst (Pt/C), a PMF surface-modified Pt/C catalyst (PMF-Pt/C), a platinum alloy catalyst (L1₀-PtCo/C) and a PMF surface modified L1₀PtCo/C catalyst (PMF-L1₀-PtCo/C) which shows the effect of the surface modification on anion poisoning.

FIG. 7 is a graph illustrating the corresponding electrochemical surface area (ECSA) changes and coverage of the surface-modifying additive PMF on the surface of the L1₀-PtCo/C catalyst with increasing surface-modifying additive amounts within the molar ratio range of 0.00-0.25.

FIG. 8A is a graph illustrating the corresponding ORR mass activity and specific activity changes in a 0.1 M HCLO₄ (perchloric acid) electrolyte of a PMF surface-modified L1₀-PtCo/C catalyst with increasing percentages of additive coverage (additive coverage percent %) of the surface of the L1₀-PtCo/C catalyst to determine the effect of additive coverage percentage on the catalyst's ORR performance.

FIG. 8B is a graph illustrating the results of a comparison of Linear Sweep Voltammetry (LSV) conducted in a 0.1M HClO₄ (perchloric acid) electrolyte to determine the electrochemical activity of catalyst and the onset potential of the ORR activity of the L1₀-PtCo/C catalyst and four different surface coverage modifications, M1, M2, M3, and M4.

FIG. 9A is a graph illustrating the corresponding ORR mass activity and specific activity changes in 0.1 M HClO₄ (perchloric acid) electrolyte+_0.1 M H₃PO₄ (phosphoric acid) electrolyte of a PMF surface-modified L1₀-PtCo/C catalyst with increasing percentages of additive coverage (additive coverage percent %) of the surface of the L1₀-PtCo/C catalyst to determine the effect of additive coverage percentage on the catalyst's ORR performance.

FIG. 9B is a graph illustrating the results of a comparison of Linear Sweep Voltammetry (LSV) conducted in a 0.1M HClO₄ (perchloric acid) electrolyte+0.1M H₃PO₄ (phosphoric acid) to determine the electrochemical activity and the onset potential of the ORR activity of the L1₀-PtCo/C catalyst and four different surface coverage modifications, M1, M2, M3, and M4.

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

The present disclosure provides a surface-modified catalyst material designed for use in proton exchange membrane fuel cells that employ phosphoric acid or phosphonated ionomers as the proton conductor or a catalyst binder and a method for mitigating phosphate poisoning of the catalyst in the membrane electrode assembly (MEA). For purposes of this disclosure, “mitigating” refers to reducing, alleviating, and/or preventing the leaking or leaching of phosphate ions and/or the negative effects of phosphate ions on the electrochemical performance of a fuel cell.

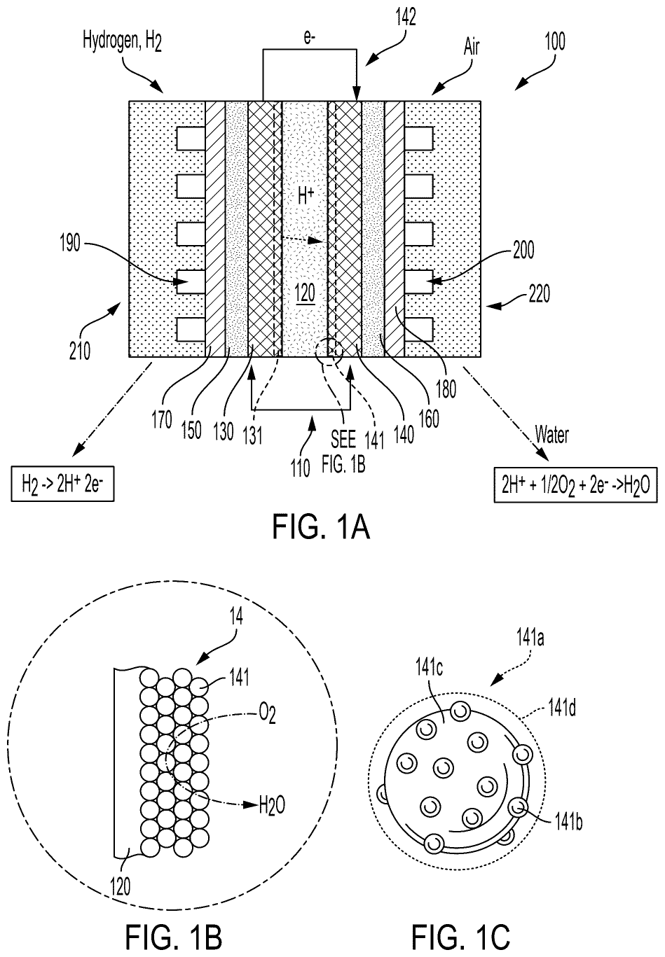

FIGS. 1A-1C illustrate the components and operation of a typical PEMFC 100, including both low-temperature proton exchange membrane fuel cells (LT-PEMFCs) and high-temperature proton exchange membrane fuel cells (HT-PEMFCs). For purposes of this disclosure, the terms “proton exchange membrane fuel cell” and “polymer electrolyte membrane fuel cell” may be used interchangeably to refer to PEMFCs generally. The PEMFC 100 includes a membrane-electrode assembly (MEA) 110, which comprises a proton exchange membrane (PEM) 120, positioned between an anode 130 and a cathode 140, and an external electrical circuit 142 that electrically connects the anode 130 and the cathode 140. A first microporous layer 150 (also referred to herein as an “anodic microporous layer” (AMPL)) contacts the anode 130. An anode gas diffusion layer (AGDL) 170 contacts the first microporous layer 150 and a first flow channel 190 contacts the anode gas diffusion layer 170. A second microporous layer (also referred to herein as a “cathodic microporous layer” (CMPL)) 160 contacts the cathode 140. A cathode gas diffusion layer (CGDL) 180 contacts the second microporous layer 160 and a second flow channel 200 contacts the cathode gas diffusion layer 180. An anode bipolar plate 210 may contact the first flow channel 190 and a cathode bipolar plate 220 may contact the second flow channel 200.

The fuel gas is typically hydrogen. The hydrogen gas may be stored in a storage tank. Optionally, hydrogen may be stored as metal hydrides or may be hydrogen obtained by reforming a hydrocarbon fuel. The oxidizing gas is typically an oxygen-containing gas. In some embodiments, the oxidizing gas is ambient air. Hydrogen and air flow within the cell are illustrated in FIG. 1A. Hydrogen (H₂) is fed to the anode side of the fuel cell and an oxygen source (such as ambient air) is fed to the cathode side of the fuel cell. At least a portion of the H₂ flows into contact with the anode 130 and migrates to the PEM 120 where H₂ molecules are catalyzed into H⁺ ions plus electrons ‘e−’ (e.g., via an anode catalyst layer 131). Also, at least a portion of the O₂ gas flows into contact with the cathode 140 and migrates to the PEM 120. The electrons e− flow through the external electrical circuit 142 to the cathode 130 and react with O₂ molecules to form O₂₋ ions (e.g., via the cathode catalyst layer 141) and the H⁺ ions diffuse through the PEM 120 to the cathode 140 and react with the O₂₋ ions to form H₂O (water), which is then transported out of the PEMFC 100 with the flow of unreacted O₂. In this manner, the Pt-containing nanoparticles assist in and enhance the reaction of O₂+e− to O₂₋ and/or O₂₋+H⁺ to H₂O and electricity is generated by the PEMFC 100. In FIG. 1A, water and excess air are depicted as exiting the cathode side of the fuel cell, and unreacted hydrogen is shown as exiting the anode side of the fuel cell.

The anode bipolar plate 280 and the cathode bipolar plate 290 can independently be made from a metal (such as titanium or stainless steel), or a carbon structure (such as graphite). Some metal bipolar plates use a carbon film coating on some or all surfaces of the bipolar plate. U.S. Pat. No. 10,283,785, incorporated herein by reference, teaches use of an amorphous carbon film in bipolar plates. In the fuel cell, the fuel gas and the oxygen gas should be separately supplied to the entire electrode surfaces without being mixed with each other. Therefore, the bipolar plates should be gas tight. Furthermore, the bipolar plates should collect electrons generated by the reaction and have good electric conductivity in order to serve as electric connectors for connecting adjoining single cells when a plurality of single cells are stacked. Moreover, because proton exchange membrane surfaces are strongly acidic, the bipolar plates provide good corrosion resistance. The main purpose of the bipolar plate in the PEMFC stack is to supply fuel (hydrogen) and oxygen to the cell and also to manage heat produced and water flow. It is also used as a backing medium for stacking individual fuel cells.

The cathode 140 includes a catalyst layer 141 with a plurality of composite particles 141a as illustrated in FIG. 1B, and the composite particles 141a include a plurality of Pt-containing nanoparticles 141b supported on the surface of carbon particles 141c as illustrated in FIG. 1C (only one carbon particle 141c shown). Referring specifically to FIG. 1C, in some examples an ionomer 141d from the PEM 120 is in contact with and at least partially surrounds the composite particles 141a. And in such examples, the ionomer 141d can poison the plurality of Pt-containing nanoparticles 141b (also known as “ionomer poisoning”) such that the efficiency of the catalyst layer 141 decreases. In addition, the plurality of Pt-containing nanoparticles 141b supported on an outer surface of the carbon particle 141c can agglomerate and/or increase in size such that an average effective size of the Pt-containing nanoparticles increases and the efficiency of the catalyst layer 432 decreases.

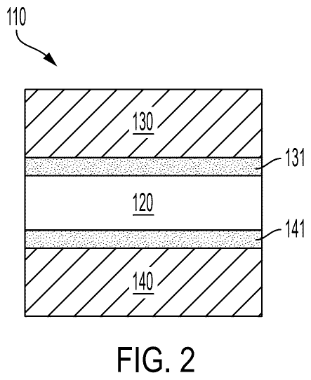

FIG. 2 is a schematic illustration of a typical membrane-electrode assembly (MEA) 110 comprising a proton exchange membrane 120, an anode 130, and a cathode 140. The anode 130 comprises an anodic catalyst layer 131, configured to electrolytically catalyze an anodic hydrogen-splitting reaction: H₂→2e⁻+2H⁺. The cathode 140 comprises a cathodic catalyst layer 141, configured to catalyze an oxygen reduction reaction: O₂+4e⁻+4H⁺→2H₂O.

The catalyst layers can be substantially formed of catalyst particles of platinum or a platinum alloy on a carbon support, such as e.g., carbon black.

Platinum is widely used as a cathode catalyst in electrochemical reactions, such as in fuel cells, because of its exceptional ability to speed up the oxygen reduction reaction (ORR). Platinum acts as an efficient catalyst during the electrochemical reduction of oxygen in a PEMFC by lowering the activation energy, stabilizing intermediates, and steering the ORR towards a more efficient and desired chemical pathway, thus significantly enhancing the overall reaction kinetics and thermodynamics on the Pt (111) surface. Platinum provides a surface that facilitates the transfer of electrons and protons to the adsorbed oxygen species, progressively reducing and splitting the molecule. The presence of platinum ensures that the reaction follows the four-electron pathway directly to water. The lowest energy state is reached with the formation of two (2) water molecules indicating this as the most stable product of the reaction pathway on Pt (111).

Platinum's unique surface properties not only adsorb and activate the reactants but also stabilize the intermediate reaction species, allowing controlled and sequential reaction steps. Previous approaches to producing catalyst particles with a higher catalytic activity and reduced loading of costly precious metals have typically involved the use of one or more components that are susceptible to corrosion in alkaline or acidic environments such as PtM, where M is a transition metal such as Ni, Co, Cu, or Fe. Over time, the gradual loss of these elements and their subsequent buildup in other critical components present within the energy conversion device, e.g., a proton exchange or electrolyte membrane, reduces both the activity level of the catalyst particles and the overall efficiency of the device.

LT-PEMFCs generally employ a proton exchange membrane that conducts protons when the membrane is properly hydrated by water. A typical commercialized membrane is perfluorinated sulfonic-acid (PFSA) having the following chemical structure:

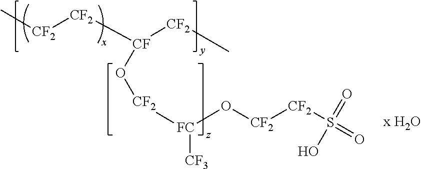

wherein x is 6.5-13.5; y is 200-1000, and z is 1. The PFSA relies on water to conduct protons so that the LT-PEMFCs can be functional. Anhydride PFSA does not conduct protons. Moreover, due to the thermal stability limitation of PFSA polymer, the LT-PEMFCs are usually not stable when operating above 120° C. (glass transition temperature of PFSA).

For HT-PEMFCs that can operate above 110° C., preferably above 140° C. and ideally between 160° C.-200° C., water cannot be used for humidifying the proton conductor (electrolyte, typically PFSA) because of the low boiling point (100° C.). A thermally stable proton conductor has to be used for such high temperatures (120° C.-200° C.). Phosphoric acid (PA) is thermally stable at this temperature range and a good proton conductor below 200° C. Above 200° C., phosphoric acid suffers from anhydride formation and evaporation. One major issue with using phosphoric acid (PA) as the proton conductor is poisoning of the oxygen reduction reaction catalyst (typically Pt catalyst). The phosphate anion from phosphoric acid adsorbs on Pt catalyst surface, blocking active sites, and reduces electrochemical surface area (ECSA) and the ability of Pt catalyst to bond with oxygen reduction reaction (ORR) intermediates for electrochemically catalyzing oxygen to form water. Higher concentrations of phosphoric acid from phosphate poisoning result in lower current densities which hinders the overall electrochemical process.

Poly (melamine-co-formaldehyde) (PMF), a surface-modifying additive, has been reported to enhance the oxygen reduction reaction (ORR) activity on Pt-based catalysts in HClO₄ (perchloric acid) electrolyte (corresponding to low-temperature PEMFCs (LT-PEMFCs)). While the mechanism is unknown, it is generally thought that the PMF surface-modifying additive weakens OH intermediate binding on Pt, which would facilitate the ORR kinetics. The present inventors have found that controlling the surface coverage of the PMF surface-modifying additive is critical to ORR activity. When coverage of the PMF surface-modifying additive on the platinum-containing nanoparticles is too low, the enhancement of ORR activity is not significant. On the other hand, when the coverage of the PMF surface-modifying additive on the platinum-containing nanoparticles is too high, the ORR activity decreases. The present inventors have also found that the optimal range of coverage of PMF surface modifying additive on the platinum-containing nanoparticles for phosphate-resistance is different in low-temperature proton exchange membrane fuel cells (LT-PEMFC) and high-temperature proton exchange membrane fuel cells (HT-PEMFC).

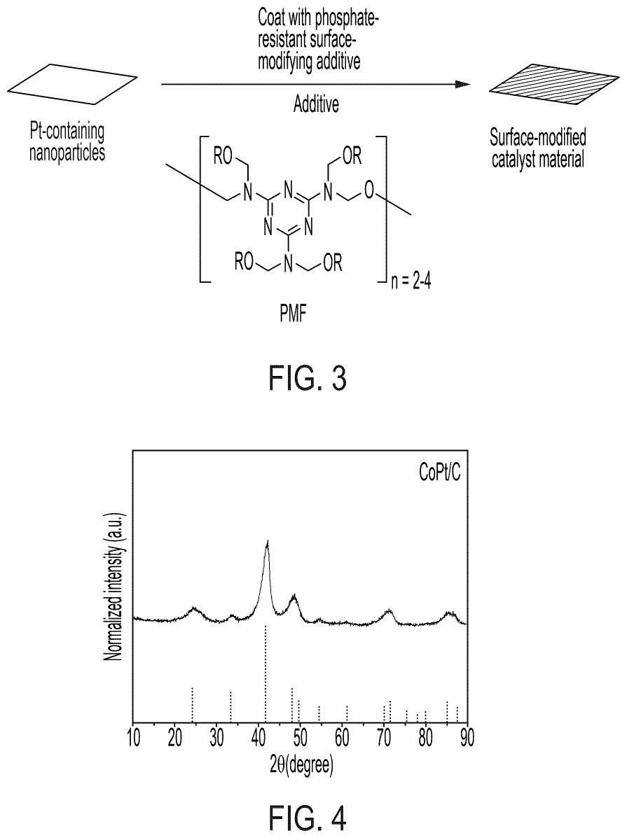

The present disclosure provides a surface-modified catalyst material comprising platinum-containing nanoparticles on a carbon support; and a phosphate resistant surface-modifying additive comprising poly (melamine-co-formaldehyde) (PMF) formed on a surface of the platinum-containing nanoparticles to form the surface-modified catalyst nanoparticles. For purposes of this disclosure, a phosphate-resistant surface-modifying additive comprising poly (melamine-co-formaldehyde) (PMF) refers to a surface modifying additive comprising PMF in an effective amount to effectuate phosphate resistance, reduction, and/or tolerance in PEMFCs. The effective amount for the PMF phosphate-resistant surface-modifying additive of the present disclosure covers from about 10% to about 40% of the surface of the surface-modified catalyst nanoparticles. FIG. 3 illustrates a method for forming the surface-modified catalyst material of the present disclosure using poly (melamine-co-formaldehyde) (PMF) as the phosphate-resistant surface-modifying additive to coat Pt-containing catalyst nanoparticles.

In some examples, the phosphate-resistant surface-modifying additive covers between about 20% to about 33% of the surface of the surface-modified catalyst nanoparticles, between about 22-33% of the surface of the surface-modified catalyst nanoparticles, or between about 22% to about 27% of the surface of the surface-modified catalyst nanoparticles. In some other examples, the phosphate-resistant surface-modifying additive covers about 40% or less, i.e., between a non-zero percent (%) to about 40% of the surface of the surface-modified catalyst nanoparticles; about 35% or less, i.e., between a non-zero percent (%) to about 35% of the surface of the surface-modified catalyst nanoparticles, or about 30% or less, i.e., between a non-zero percent (%) to about 30% of the surface of the surface-modified catalyst nanoparticles, or about 26% or less, i.e., between a non-zero percent (%) to about 26%, of the surface-modified catalyst nanoparticles.

The catalyst layer includes metal catalyst particles, or catalytic metal particles on a carbon support. In some examples, the metal catalyst particles, or catalytic metal particles, are nanoparticles in admixture with or supported by particles of another material, such as carbon, which can be selected from carbon black, graphene, nitrogen-doped carbon, activated carbon, and carbon nanotubes, to form catalyst nanoparticles on a carbon support.

The catalyst particles comprise platinum-containing particles, such as PtM or alloy nanoparticles, where M is a metal selected from copper (Cu) iron (Fe), cobalt (Co), nickel (Ni), palladium (Pd), ruthenium (Ru), iridium (Ir), and the like, and combinations thereof. Ordered intermetallic PtM-based nanoparticles, where M is a transition metal, have attracted attention for providing significantly improved activity and durability for ORR. Compared to alloy nanoparticles, ordered intermetallic PtM-based nanoparticles show a strong atomic interaction between Pt and M leading to high chemical and structural stability, and modulation of the composition ratio of M to Pt to achieve higher mass activity (MA) for the ORR. Recent density functional theory studies have shown that both the linear compressional and shear strain effects provided by 3D alloying elements in PtM contribute to the optimal adsorption on the reaction intermediates. Thus, it is considered that inducing tensile strains within the Pt surface of PtM catalysts will improve the ORR kinetics. However, too much tensile strain can damage the structure of PtM catalysts and the stability of the ORR. Therefore, controlling tensile strain is important.

The platinum (Pt) containing nanoparticles of the present disclosure may have a core/shell structure wherein the core particles are encompassed by a platinum shell. In at least one example of the present disclosure, the core comprises intermetallic L1₀ structured cobalt platinum catalyst nanoparticles on a carbon support (L1₀-PtCo/C). The terms “L1₀-PtCo/C” and IM-PtCo/C” may be used interchangeably within this disclosure. Additionally, the abbreviations “L1₀”, “L1₀-phase”, and “IM” may also be used interchangeably within this disclosure to refer to the intermetallic, ordered structure of the platinum containing catalysts of catalysts of the present disclosure. The L1₀-PtCo/C catalyst nanoparticles may have a particle size in the range of about 2 to about 20 nm. As used herein, “intermetallic L1₀ structured” refers to the compound structure wherein the metallic elements have a defined stoichiometry and ordered crystal structure characterized by a specific regular, periodic arrangement of the different metal atoms in alternating layers along one axis, while maintaining a face centered cubic (fcc) arrangement perpendicular to that axis. The intermetallic L1₀ structure can be confirmed by X-Ray diffraction (XRD). The peaks should match well with the standard pattern and include the characteristic peak 33.3°. The intermetallic L1₀ structured core influences electronic properties and surface energies and provides structural stability to the nanoparticles.

The nanoparticle cores may be spherical or spheroidal in shape It is to be understood, however, that the particles may take on any shape or structure which includes, but is not limited to branching, conical, pyramidal, cubical, cylindrical, nanowires, mesh, fiber, octahedral, cuboctahedral, icosahedral, and tubular nanoparticles. The nanoparticles may be agglomerated or dispersed, formed into ordered arrays, fabricated into an interconnected mesh structure, either formed on a supporting medium or suspended in a solution, and may have even or uneven size distributions. The particle shape and size may be configured to maximize surface catalytic activity. Throughout this specification, the exemplary nanoparticles will be primarily disclosed and described as substantially spherical in shape.

In the case wherein the platinum-containing particles comprise a core/shell structure, the platinum shell is a thin layer of platinum with 1-4 Pt monolayers. Once nanoparticles having the desired shape, composition, and size distribution have been fabricated, the desired shell layer may then be formed. The particular process used to form the shell layer is not intended to be limited to any particular process but is generally intended to be such that it permits formation of films having thicknesses in the monolayer-to-multilayer thickness range. It is to be understood, however, that while the process of preparing core-shell nanoparticles is described sequentially, the cores and the shells of the core-shell nanoparticles can also be formed in parallel.

For purposes of this specification, a monolayer (ML) is formed when the surface of a substrate, e.g., a nanoparticle, is fully covered by a single, closely packed layer comprising adatoms of a second material which forms a chemical or physical bond with atoms at the surface of the substrate. The surface is considered fully covered when substantially all available surface sites are occupied by the adatoms of the second material. The surface may be considered fully covered when more than 90% of all available surface sites are occupied by the adatoms of the second material, or when more than 95% of all available surface sites are occupied by the adatoms of the second material. When more than about 90% of all available surface sites are occupied, the shell is considered to be continuous and nonporous. If less than 90% of the surface sites of the substrate are not completely occupied, then the surface coverage is considered to be sub monolayer (or may be non-continuous). However, if a second layer or subsequent layers of the adsorbent are deposited onto the first layer, then multilayer surface coverages, e.g., bilayer, trilayer, etc., result and are considered continuous and nonporous. Multilayer surface coverages may result and be considered continuous and nonporous cumulatively together, whereas individually each layer may be non-continuous.

The size and shape of the catalytic metal particles can be optimized to maximize total surface area of the catalyst and reaction sites available to participate in the reactions per volume of catalyst used. In some examples, the particles of a catalytic metal may have a specific surface area of at least 10 m²/g, or 20 m²/g, or 30 m²/g, or 40 m²/g, or 50 m²/g, or 60 m²/g, or 70 m²/g, or 80 m²/g, or 90 m²/g, or 100 m²/g. In some examples, the particles of a catalytic metal will be nanoparticles having an average maximum dimension of less than 100 nm, or less than 90 nm, or less than 80 nm, or less than 70 nm, or less than 60 nm, or less than 50 nm, or less than 40 nm, or less than 30 nm, or less than 20 nm, or less than 10 nm. In some specific examples, the catalyst composition will include platinum nanoparticles having an average maximum dimension of 2-5 nm in diameter. In some examples, the particles of a catalytic metal will include porous particles. In some examples, the particles are nanoparticles, nanowires, nanorods, nanoframes, and facet-controlled shapes.

The proton exchange membrane and the polymeric ionomer layer comprise specialized polymer materials having proton conductivity and thermal stability, which is advantageous for use in HT-PEMFCs. Suitable polymers for the proton exchange membrane and/or polymeric ionomer layer of the present disclosure include but are not limited to, phosphoric acid doped polybenzimidazole (PA/PBI), quaternary ammonium phosphate ion pair polymers, polyvinylphosphonic acid (PVPA), sulfonated polyether ether ketone (SPEEK), poly(arylene ether sulfone) (PAES), sulfonated polyimides, perfluorosulfonic acid (PFSA) polyvinylidene fluoride (PVDF) copolymers, and combinations thereof. The polymers may be blended or used to compose composite membranes.

The L1₀PtCo/C—Pt-shell nanoparticle catalyst can be prepared by wet impregnation of cobalt precursors onto a commercial Pt/C catalyst (TEC10V10E).

The present disclosure also provides a proton exchange membrane fuel cell (PEMFC) comprising a surface-modified catalyst material comprising platinum-containing nanoparticles on a carbon support; and a phosphate-resistant surface-modifying additive comprising poly (melamine-co-formaldehyde) (PMF) formed on a surface of the platinum-containing nanoparticles to form surface-modified catalyst nanoparticles; wherein the phosphate-resistant surface-modifying additive covers between 10% and 40% of the surface of the surface-modified catalyst nanoparticles. The present inventors have surprisingly found that the optimal range of surface coverage of the platinum-containing nanoparticles by the phosphate-resistant surface-modifying additive is different in low-temperature proton exchange membrane fuel cells (LT-PEMFC) and high-temperature proton exchange proton exchange membrane fuel cells (HT-PEMFC). In a high-temperature proton exchange membrane fuel cell (HT-PEMFC), the phosphate-resistant surface-modifying additive optimally covers about 22% to about 33% of the surface of the surface-modified catalyst nanoparticles.

The present disclosure also provides a method for mitigating phosphoric acid poisoning in polymer electrolyte fuel cells comprising phosphoric acid or phosphonated ionomers as a proton conductor or a catalyst binder. The method involves providing at least one catalyst layer which comprises a surface-modified catalyst material to an electrode in a proton exchange membrane fuel cell (PEMFC), wherein the surface-modified catalyst material comprises platinum-containing nanoparticles on a carbon support; and a phosphate-resistant surface-modifying additive comprising poly (melamine-co-formaldehyde) (PMF) formed on a surface of the platinum-containing nanoparticles to form surface-modified catalyst nanoparticles. The phosphate-resistant surface-modifying additive covers between about 10% and 40% of the surface of the surface-modified catalyst nanoparticles.

The surface-modified catalyst material, PEMFCs employing the surface-modified catalyst material, and methods for mitigating phosphoric acid poisoning of the present disclosure can be applied to fuels cells that involve the use of phosphoric acid as a proton conductor in the membrane electrode assembly (MEAs) including, but not limited to phosphoric acid fuel cells (PAFCs), phosphoric acid doped polybenzimidazole (PA/PBI) membrane PEMFC (PA/PBI PEMFC) and HT-PEMFCs based on quaternary ammonium biphosphate ion-pair coordination (ion-pair HT-PEMFCs). Such fuel cells can be useful for stationary power generation for buildings and industrial applications, automotive applications such as high-efficiency, quick-start fuel cells for vehicles, and portable power devices requiring density and durability.

### EXAMPLES

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Materials

Materials used include platinum on carbon (TEC10V10E and TEC10V20E, TKK); cobalt (II) acetylacetonate (Co(acac)₂, 97%; Sigma-Aldrich): chloroform (Sigma-Aldrich); methanol (certified ACS; Fisher Scientific); isopropanol (certified ACS; Fisher Scientific); n-propanol (spectroscopy grade, Fisher Scientific); acetic acid (glacial, Fisher Scientific); deionized-water (18.2 W, Q-series, Milipore); nitrogen (N₂, UHP grade, Airgas); forming gas (6% H₂ balanced with Ar, Airgas); oxygen (O₂, UHP grade, Airgas); NAFION® lonomer solution (D2020, Ion Power). All chemicals were used as received without further purification.

### Synthesis

### Example S1. Synthesis of L1₀-PtCo Catalyst

100 mg Pt/C was dispersed in 25 mL of chloroform in a clean glass bottle via ultrasonication. After 1 hour, the designated amount of Co(acac)₂ (dissolved in chloroform, 5 mL) was introduced into the Pt/C-chloroform mixture and was kept under sonicating conditions for 30 min. To remove excess solvents, the mixture bottle was stirred under 300 rpm with a magnetic stir bar at open-cap conditions on a 70° C. magnetic hot-plate stirrer for 2 hours. The remaining thick solution/slurry was then transferred to a watch glass to allow the final drying of the Co-impregnated Pt/C sample. To induce the alloying of Co and Pt and the further transformation into ordered L1₀ phase, the dry powders were thermally treated under a flow of forming gas (6% H₂ balanced with Ar) at 700° C. with a ramp rate of 10° C./min in a quartz tube furnace (Thermo-Lindberg Minimite). After 12 hours of treatment at 700° C., the samples were naturally cooled down under a flow of forming gas. At room temperature, before exposure to air, the quartz tube was purged with N₂ to prevent co-exposure of catalyst to H₂ and air. The annealed sample was further treated with acetic acid in an ultrasonic bath at room temperature for 30 min to remove the non-alloyed Co species and finally washed by methanol. The washing included sonication of powder samples in methanol and separation by centrifugation for at least 3 repetitive cycles.

XRD of the L1₀-PtCo/C is provided in FIG. 4 indicating the formation of the intermediate L1₀ phase.

### Example S2. Synthesis of L1₀-PtCo/C—Pt Shell Catalyst

The as-synthesized L1₀-PtCo/C was used as the starting material to prepare L1₀-PtCo/C—Pt— shell catalyst. In a typical process, 100 mg of L1₀-PtCo/C catalyst was mixed with 50 mL of acetic acid in a round bottom flask. Ultrasonication was applied to the mixture to enhance the dispersion of catalyst powders. The flask was then immersed into an 80° C. oil bath and stirred at 500 rpm. After hours, the mixture was naturally cooled to room temperature. The treated catalysts were then separated by centrifugation followed by washing with methanol and drying in a vacuum oven as mentioned in the previous section. The dried sample was then thermally treated at 400° C. for 2 hours to induce the formation of a smooth Pt shell on top of the L1₀ core and naturally cooled down under forming gas in a quartz tube furnace. At room temperature, before exposure to air, the quartz tube was purged with N₂ to prevent mixing of H₂ and air over the catalyst.

### Example S3. Surface Modification of the L1₀-PtCo/C—Pt Shell Catalyst

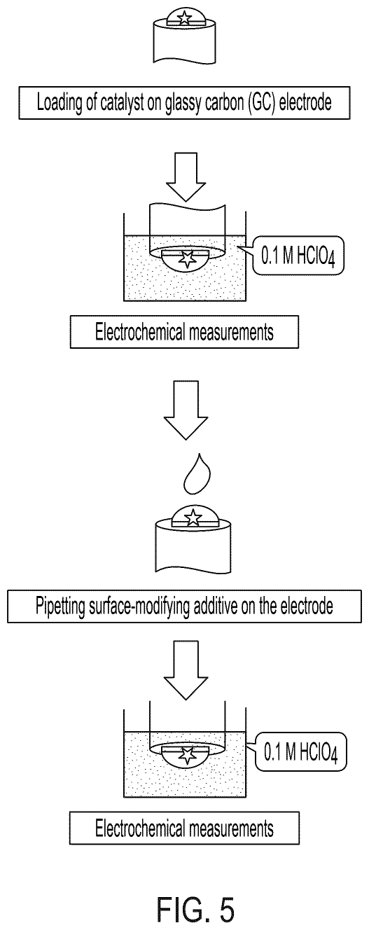

As illustrated in FIG. 5, the as synthesized L1₀-PtCo/C catalyst nanoparticles are loaded on a glassy carbon (GC) electrode. After initial CV and LSV recordings, 3.6 μL of PMF solution (5 wt % in butanol) was dropped on the GC working electrode and dried under air-saturated conditions, followed by CV and LSV measurements (Pt loading: 20.0 μg cm⁻²).

### Example S4. Synthesis of Pt/C Catalyst

A standard Pt/C catalyst was prepared by thermally treating commercial TEC10V10E PtC/C catalyst material under a flow of forming gas at 700° C. with a ramp rate of 10° C./min in a quartz tube furnace for 12 h. Likewise, the samples were naturally cooled down under forming gas and purged with N₂ before removal from the quartz tube.

### Example S5. Surface Modification of the Pt/C Catalyst

The as synthesized Pt/C catalyst nanoparticles are loaded on a glassy carbon (GC) electrode. After initial CV and LSV recordings, 3.6 μL of PMF solution (5 wt % in butanol) was dropped on the GC working electrode and dried under air-saturated conditions, followed by CV and LSV measurements (Pt loading: 20.0 μg cm⁻²).

### Performance Evaluation

### Example 1. Effect of Surface Modification on ECSA Activity

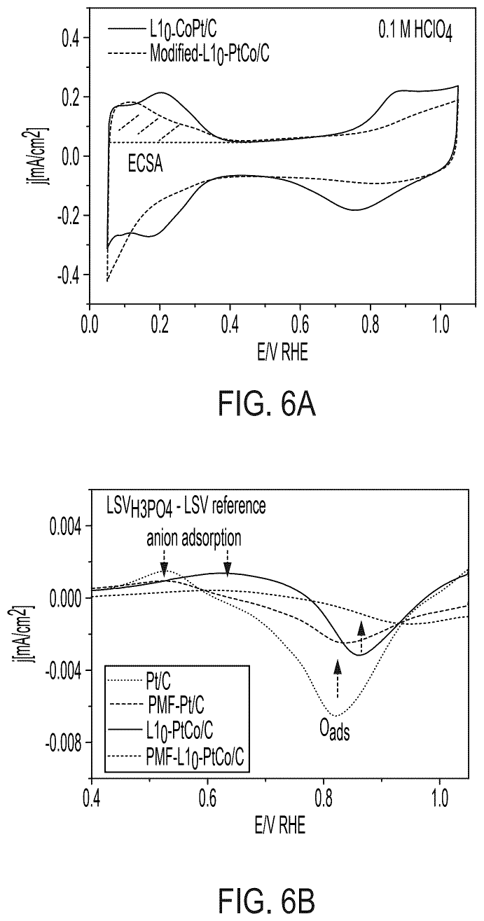

FIG. 6A is a cyclic voltammogram (CV) graph of L1₀-PtCo/C before and after surface modification with poly (melamine-co-formaldehyde) (PMF) (Modified-L1₀Pt/Co/C). The x-axis represents the applied potential (E) versus the Reversible Hydrogen Electrode (RHE), a reference electrode. The y-axis represents the current density of the electrode (j) in milliamperes per square centimeter (mA/cm²). The solid black line (-) represents the CV of the L1₀-PtCo/C catalyst before surface modification and the dashed line (---) represents the CV of a PMF surface-modified L1₀-PtCo/C catalyst. As shown in FIG. 6A, the PMF surface-modified L1₀-PtCo/C catalyst shows a lower current density in the ORR region as compared to the unmodified L1₀-PtCo/C catalyst. Thus, it can be seen that modifying the electrode surface with poly (melamine-co-formaldehyde) (PMF) results in the decrease of the electrochemical surface area (ECSA). The decreased electrochemical surface area percentage can be used to describe the surface-modifying additive coverage on the surface of the platinum-containing nanoparticles.

### Example 2. Effect of Surface Modification on Anion Poisoning

FIG. 6B shows the effect of surface modification on reducing anion poisoning. FIG. 6B is a graph illustrating the comparison of linear sweep voltammetry curves (LSV) of a standard platinum on carbon catalyst (Pt/C), a PMF surface-modified Pt/C catalyst (PMF-Pt/C), a platinum alloy catalyst (L1₀-PtCo/C) and a PMF surface modified L1₀PtCo/C catalyst (PMF-L1₀-PtCo/C) which shows the effect of the surface modification on anion poisoning. The data shows the difference between the LSVs obtained in H₃PO₄ and the reference phosphoric acid solution. The unmodified L1₀-PtCo/C catalyst shows a large dip in the (O_{ads}) oxygen adsorption curve in the 0.7-0.9 V RHE region indicating strong ORR activity, but more susceptibility to phosphate poisoning. The PMF-modified catalysts PMF-Pt/C and PMF-L1₀-PtCo/C show less significant dips in the (O_{ads}) oxygen adsorption curves as compared to the respective unmodified Pt/C and L1₀-PtCo/C catalysts indicating changes in the surface chemistry of the active sites on the catalysts. The altered electrochemical behavior of the surface modified catalysts particularly in the anion adsorption region (˜0.6 to 0.8 V) indicates that the PMF surface-modifying additive helps to reduce phosphate ion adsorption, thereby improving the surface-modified catalysts tolerance to phosphate poisoning.

### Example 3. Effect of Increasing Surface Additive Coverage Percentage

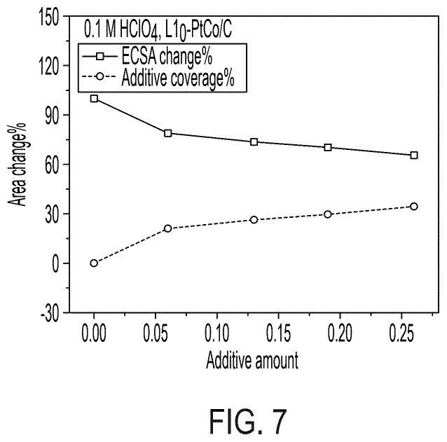

FIG. 7 is a graph illustrating the corresponding electrochemical surface area (ECSA) changes and coverage of the surface-modifying additive PMF on the surface of the L1₀-PtCo/C catalyst with increasing surface-modifying additive amounts within the molar ratio range of 0.00-0.25. As shown in FIG. 7, as more PMF is added to the electrode, the ECSA decreases indicating the increasing coverage of PMF on the surface of the L1₀-PtCo/C catalyst nanoparticles.

### Example 4. Effect of Surface-Modifying Additive Coverage on Catalyst Performance (0.1M HClO₄ (Perchloric Acid))

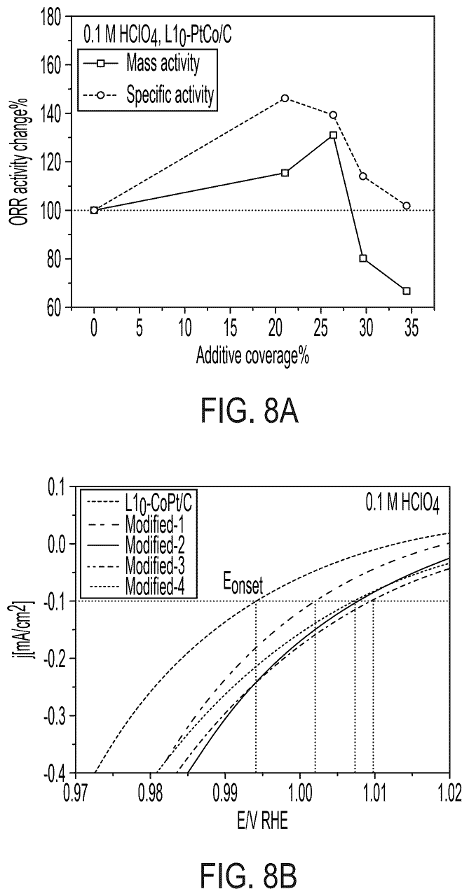

FIG. 8A is a graph illustrating the corresponding ORR mass activity and specific activity changes in a 0.1 M HCLO₄ (perchloric acid) electrolyte of a PMF surface-modified L1₀-PtCo/C catalyst with increasing percentages of additive coverage (additive coverage percent %) of the surface of the L1₀-PtCo/C catalyst to determine the effect of additive coverage percentage on the catalyst's ORR performance. In FIG. 8A, it can be seen that the PMF surface-modifying additive facilitates the ORR activity in 0.1M HClO₄ (perchloric acid) electrolyte as the specific activity increases. Such increase was found to be related to the optimized OH intermediate binding on the modified surface. At low additive coverage between about 2-5% both the mass activity and the specific activity remain at, or are relatively close to 100%. As the surface-modifying additive coverage increases to about 20-27%, there is a noticeable increase in both the mass activity and the specific activity, with specific activity showing a sharper rise. However, beyond about 27% surface-modifying additive coverage, both the mass activity and the specific activity begin to sharply decline with specific activity dropping more sharply. By 30% surface-modifying additive coverage, the ORR activity falls below baseline indicating that excessive coverage by the PMF-surface modifying additive is disadvantageous.

FIG. 8B is a graph illustrating the results of a comparison of Linear Sweep Voltammetry (LSV) conducted in a 0.1M HClO₄ (perchloric acid) electrolyte to determine the electrochemical activity of catalyst and the onset potential of the ORR activity of the L1₀-PtCo/C catalyst and four different surface coverage modifications, Modified-1 (M1), Modified-2 (M2), Modified-3 (M3), and Modified-4 (M4). It can be seen that the L1₀-PtCo/C catalyst has the highest catalytic activity as indicated by the lowest current density at the given potential, indicating better ORR kinetics as compared to the modified catalysts M1 to M4, which show higher current densities (more negative) at the same potential with M1 having the least surface modification among M1, M2, M3 and M4. Thus, the data shows that, unexpectedly, the higher coverage percentage is not the optimal coverage.

### Example 5. Effect of Surface-Modifying Additive Coverage on Catalyst Performance (0.1M HClO₄ (Perchloric Acid)+H₃PO₄)

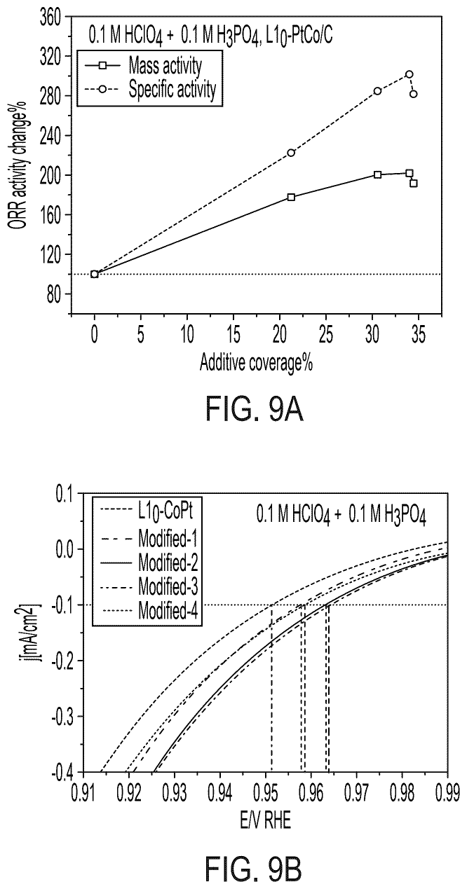

FIG. 9A is a graph illustrating the corresponding ORR mass activity and specific activity changes in 0.1 M HClO₄ (perchloric acid) electrolyte+_0.1 M H₃PO₄ (phosphoric acid) electrolyte of a PMF surface-modified L1₀-PtCo/C catalyst with increasing percentages of additive coverage (additive coverage percent %) of the surface of the L1₀-PtCo/C catalyst to determine the effect of additive coverage percentage on the catalyst's ORR performance. In FIG. 9A, as the ratio of the PMF surface-modifying additive coverage increases, the mass activity shows a less pronounced increase due to the loss of the reaction sites on the surface of the catalyst. Beyond about 33% coverage, the increase in specific activity starts to plateau or slightly decrease, indicating that the benefits of further additive application diminish. Mass activity also shows a similar trend but with a less pronounced decline. The peak mass activity is observed at ˜33% (M3). An overall mass activity improvement can be seen with the surface-modifying additive coverage of less than 26%, and the best performance is observed with the additive coverage to be about 26%. The results suggest that the surface additive coverage ratio (i.e., percentage %) can be more flexible for the applications in phosphoric acid.

FIG. 9B is a graph illustrating the results of a comparison of Linear Sweep Voltammetry (LSV) conducted in a 0.1M HClO₄ (perchloric acid) electrolyte+0.1M H₃PO₄ (phosphoric acid) showing a comparison of onset potential with different additive coverage from M1 to M4 to determine the electrochemical activity and the onset potential of the ORR activity of the L1₀-PtCo/C catalyst and four different surface coverage modifications, M1, M2, M3, and M4. From FIG. 9B it can be seen that in phosphoric acid solution, the specific activity and mass activity trends differ from that in HClO₄. Within the range of PMF surface-modifying additive coverage observed with modifications M1, M2, M3, M4 (0-35%), the overall mass activity is improved after adding the surface-modifying additive. Modified-1 (M1) and Modified-2 (M2) perform better than Modified-3 (M3) and Modified-4 (M4) in terms of maintaining a higher onset potential, indicating better resistance to phosphate poisoning or less impact on ORR activity. The following Table provides a summary of the experimental results from the experimental tests conducted in the examples discussed above and specifically the graphs in FIGS. 6A, 6B, 9A and 9B.

PMF COVERAGE ACTIVITY RELATIONSHIP L1₀-PtCo

| | | O_{ads} | E_{ORR-onset} | Eₒₙₛₑₜ-H₃PO₄ |
|---|---|---|---|---|
| L1₀-PtCo | ECSA % | (%) | (mV) | (mV) |
| Blank | 100 | 0 | 994.2 | 951.4 |
| M1 | 79.0 | 29.0 | 1002.0 | 957.9 |
| M2 | 73.6 | 26.4 | 1007.3 | 963.1 |
| M3 | 70.4 | 29.6 | 1009.6 | 963.7 |
| M4 | 65.6 | 34.4 | 1007.5 | 958.7 |

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A surface-modified catalyst material comprising
platinum-containing nanoparticles on a carbon support; and
a phosphate-resistant surface-modifying additive comprising poly (melamine-co-formaldehyde) (PMF); formed on a surface of the platinum-containing nanoparticles to form surface-modified catalyst nanoparticles; and
wherein the surface-modifying additive covers between 10 to 40% of the surface of the surface-modified catalyst nanoparticles.

2. The surface-modified catalyst material according to claim 1, wherein the phosphate-resistant surface-modifying additive covers between 20 to 35% of the surface of the surface-modified catalyst nanoparticles.

3. The surface-modified catalyst material according to claim 1, wherein the phosphate-resistant surface-modifying additive covers about 30% or less of the surface of the surface-modified catalyst nanoparticles.

4. The surface-modified catalyst material according to claim 1, wherein the phosphate-resistant surface-modifying additive covers about 26% or less of the surface of the surface-modified catalyst nanoparticles.

5. The surface modified catalyst material according to claim 1, wherein the platinum-containing nanoparticles comprise platinum alloyed with a second metal selected from nickel (Ni), cobalt (Co), iron (Fe), and copper (Cu).

6. The surface-modified catalyst material according to claim 1, wherein the platinum-containing nanoparticles comprise nanoframes, nanowire, and facet-controlled shapes.

7. The surface-modified catalyst material according to claim 1, wherein the platinum-containing nanoparticles have a core-shell structure.

8. The surface-modified catalyst material according to claim 1, wherein the platinum-containing nanoparticles have a non-platinum core surrounded by a platinum shell.

9. The surface-modified catalyst material according to claim 1, wherein the platinum-containing nanoparticles are intermetallic L1₀₋PtCo catalyst nanoparticles supported on carbon (L1₀-PtCo/C).

10. The surface-modified catalyst material according to claim 9, wherein the L1₀-PtCo/C catalyst nanoparticles supported on carbon (L1₀-PtCo/C) have a particle size in a range of about 2 to about 20 nm.

11. A proton exchange membrane fuel cell (PEMFC) comprising a surface-modified catalyst material comprising platinum-containing nanoparticles on a carbon support; and a phosphate-resistant surface-modifying additive comprising poly (melamine-co-formaldehyde) (PMF) formed on a surface of the platinum-containing nanoparticles to form surface-modified catalyst nanoparticles; and wherein the phosphate-resistant surface-modifying additive covers between 10 and 40% of the surface of the surface-modified catalyst nanoparticles.

12. The proton exchange membrane fuel cell (PEMFC) according to claim 11, which is a high-temperature proton exchange membrane fuel cell (HT-PEMFC), and wherein the phosphate-resistant surface-modifying additive covers about 22% to about 33% of the surface of the surface-modified catalyst nanoparticles.

13. A method for mitigating phosphoric acid poisoning in polymer electrolyte fuel cells comprising phosphoric acid or phosphonated ionomers as a proton conductor or a catalyst binder, said method comprising:
providing at least one catalyst layer which comprises a surface-modified catalyst material to an electrode in a proton exchange membrane fuel cell (PEMFC), wherein the surface-modified catalyst material comprises
platinum-containing nanoparticles on a carbon support; and
a phosphate-resistant surface-modifying additive comprising poly (melamine-co-formaldehyde) (PMF) formed on a surface of the platinum-containing nanoparticles to form surface-modified catalyst nanoparticles; and
wherein the phosphate-resistant surface-modifying additive covers between 10 to 40% of the surface of the surface-modified catalyst nanoparticles.

14. The method according to claim 13, wherein the phosphate-resistant surface-modifying additive covers about 22% to about 33% of the surface of the surface-modified catalyst nanoparticles.

15. The method according to claim 13, wherein the phosphate-resistant surface-modifying additive covers about 30% or less of the surface of the surface-modified catalyst nanoparticles.

16. The method according to claim 13, wherein the phosphate-resistant surface-modifying additive covers about 26% or less of the surface of the surface-modified catalyst nanoparticles.

17. The method according to claim 13, wherein the platinum-containing nanoparticles have a core-shell structure.

18. The method according to claim 13, wherein the platinum-containing nanoparticles have a non-platinum core surrounded by a platinum shell.

19. The method according to claim 13, wherein the platinum-containing nanoparticles are intermetallic L1₀-PtCo catalyst nanoparticles supported on carbon (L1₀-PtCo/C).

20. The method according to claim 19, wherein the L1₀-PtCo catalyst nanoparticles supported on carbon (L1₀-PtCo/C) have a particle size in a range of about 2 to about 20 nm.
